(19) United States
(12) Patent Application Publication
(10) Pub. No.: US 2020/0201299 A1
(43) Pub. Date: Jun. 25, 2020

(54) METHOD AND APPARATUS FOR COMPUTER AIDED OPTIMIZATION OF AN OCCUPANCY OF MAGAZINE SLOTS BY TOOLS WITHIN AT LEAST ONE TOOL MAGAZINE FOR A MACHINE TOOL

(71) Applicant: Siemens Aktiengesellschaft, München (DE)

(72) Inventor: Christian Royer, Ottobrunn (DE)

(21) Appl. No.: 16/645,947

(22) PCT Filed: Sep. 14, 2017
(86) PCT No.: PCT/EP2017/073206

§ 371 Date: Mar. 10, 2020

(51) Int. Cl. G05B 19/418; G05B 19/4093; G05B 19/18

(52) U.S. Cl. CPC G05B 19/4187; G05B 19/40938; G05B 2219/33124; G05B 2219/32257; G05B 2219/32276; G05B 19/182

(57) ABSTRACT

Provided is a method and device for computer-assisted optimization of the occupancy of magazine spaces by tools within at least one tool magazine for a machine tool, one or more workpieces of a workpiece type being manufactured with the aid of the tools provided by a magazine unit at a provisioning place. A step of the claimed steps of the method described in the description is the optimization of the occupancy of the magazine spaces by tools so that the total waiting time is minimized, wherein the total waiting time is composed of individual waiting times which result in each case from the difference between the detected provisioning period and the detected working step duration if the value of the difference is positive, otherwise the individual waiting time assumes the value zero.

### CROSS-REFERENCE TO RELATED APPLICATIONS

This application claims priority to PCT Application No. PCT/EP2017/073206, having a filing date of Sep. 14, 2017, the entire contents of which are hereby incorporated by reference.

### FIELD OF TECHNOLOGY

The following relates to a method and an apparatus for computer-aided optimization of an occupancy of magazine slots by tools within at least one tool magazine for a machine tool.

### BACKGROUND

A machine tool is an automated manufacturing facility that is used to produce a prescribed shape on a workpiece by means of one or more tools. Multiple tools can be associated with one tool type, e.g. milling. Another tool type can be e.g. drilling. A machine tool has a tool spindle in which the machining tool, also called the spindle tool, is located during machining.

The tools that can be used by the machine tool to machine a workpiece are stored in a tool magazine. There are various types of these. One form used very frequently is chain-type magazines, which are used e.g. in the automotive industry.

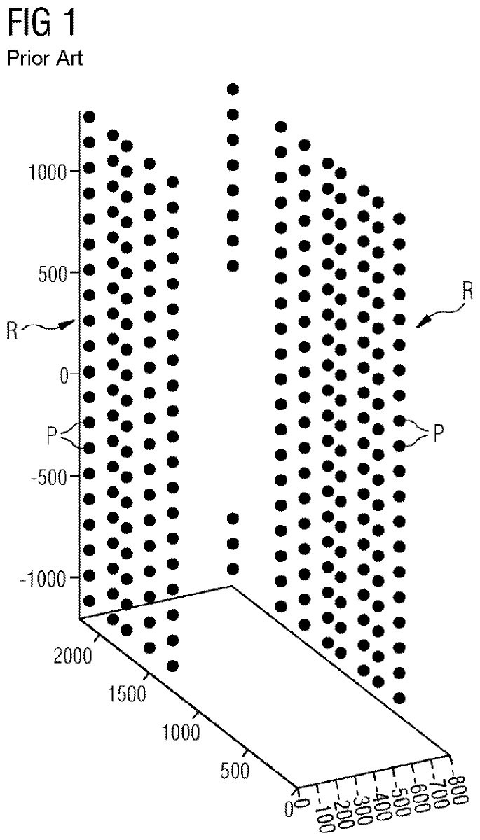

Another magazine type is shelf-type magazines R, as indicated in FIG. 1, for example, in which very many different tools can be accommodated (up to 500 tools or even possibly more). The tools are stored therein in permanent magazine slots P. Such a magazine can consist of a main side and a facing opposite side.

The shelf-type magazine has an apparatus, in particular a magazine device, which is not depicted in FIG. 1, that can be used to store and fetch a tool in its magazine slot P. This magazine type is used particularly when a greater variety of different workpieces, for which a multiplicity of different tools are needed, is supposed to be produced using a machine tool.

A workpiece of a specific workpiece type is machined using a prescribed sequence of tools. It is entirely possible for a tool to occur repeatedly in this sequence. The sequence is the same for all workpieces of a workpiece type, e.g. car seat. The sequence can be a different one for workpieces of another workpiece type.

During a work step of machining a workpiece using a tool of the sequence, the spindle tool, the “predecessor tool” of the preceding work step is returned to or replaced in its magazine slot in the shelf-type magazine. An empty run is then made to the magazine slot of the “successor tool” of the subsequent work step. The tool is then picked up and transported to a supply point. When the current work step, i.e. the machining using the current spindle tool, is finished, the tool in the spindle is exchanged (e.g. using a tool changer). If the machining using the spindle tool is finished but the successor tool is not yet available for the next work step, a waiting period arises for the spindle supply. These individual waiting periods reduce machine efficiency and increase the production time. These waiting periods should therefore be avoided.

When minimizing the waiting periods for the spindle supply during the production of a prescribed or prescribable set of workpieces of one or more workpiece types, the following restrictions must be heeded:

A tool cannot usually be put into any magazine slot, i.e. there are permissible magazine slots and prohibited magazine slots for the tool:

The magazine slot type of the tool and the magazine slot type of the magazine or shelf slot must be compatible. As such, e.g. large tools cannot be put in magazine slots for small tools, and possibly vice versa.

Tools must not jut out at the edge.

There must be no tools at closed magazine slots.

If tools are oversize, one or possibly even more adjacent magazine slots need to be released.

The initial situation is usually a shelf-type magazine filled (possibly even very full) with tools. In order to be able to heed the aforementioned restrictions, the tools are moved in the shelf-type magazine. This cannot be performed during peak times (i.e. while production is in progress) and therefore entails a downtime for the machine tool. In this context, it makes sense to assign as many tools as possible back to the old magazine slot.

### SUMMARY

An aspect relates to optimize machine efficiency and, with it, in particular the aforementioned waiting periods.

Embodiments of the invention claim a method for computer-aided optimization of an occupancy of magazine slots by tools within at least one tool magazine for a machine tool, wherein one or more workpieces of a workpiece type are manufactured by using the tool provided by a magazine device at a supply point, having the following steps:
a) detecting a set of magazine slots in at least one tool magazine,
b) detecting a set of tools,
c) detecting permissible tools per magazine slot,
d) detecting a sequence of work steps to be performed by the machine tool on a workpiece, wherein a tool envisaged for a work step of the sequence is used to manufacture the workpiece,
e) detecting work step times that are each needed to perform an individual work step on the workpiece,
f) detecting one or more supply times, on the basis of the sequence of work steps to be performed and the occupancy of the magazine slots, that are each needed by the magazine device at the supply point to provide a tool for the next work step,
g) optimizing the occupancy of the magazine slots by tools, so that the overall waiting period is minimized, wherein the overall waiting period is made up of individual waiting periods that each result from the difference between the detected supply time and the detected work step time if the value of the difference is positive, otherwise the individual waiting period assumes the value zero.

The supply time can be made up of a fetch time, which comprises the time for the magazine device to fetch a tool to the supply point from one magazine slot permissible for the tool, and of a replace time, which comprises the time for the magazine device to replace a tool from the supply point to one magazine slot permissible for the tool, and of an empty-run time for an empty run by the magazine device from a first magazine slot to another, second magazine slot.

If the next work step is the first work step in the sequence of work steps, then there is no replace time, i.e. the replace time is zero, and no empty run, i.e. the empty-run time is zero.

Allowance can be made for all magazine slot pair combinations of first and second magazine slots. The number of magazine slot pair combinations can be reduced if need be by virtue of allowance being made for them on the basis of the tools to be used in the order of the work steps within the sequence.

Moreover, a set of workpiece types and quantities of the workpieces to be manufactured of each workpiece type of the set can be detected and allowance can be made for these in optimizing the occupancy of the magazine slots by tools.

The optimization can be performed by means of mixed integer linear optimization or by means of a heuristic integer linear optimization, each of which is explained in more detail in the exemplary embodiments below.

One development of embodiments of the invention provides for further steps of:

detecting a set of all half-slots,

detecting a subset of half-slots covered whenever there is a tool in one magazine slot, wherein allowance is made for these sets when optimizing the occupancy, with the aim of no half-slot being covered by multiple tools.

A magazine slot can comprise one or more half-slots. These can be situated to the left, to the right or above or below. They are locations at the respective magazine slot that can be covered by other tools at adjacent magazine slots.

One development of embodiments of the invention provides for the optimization of the occupancy of the magazine slots by tools to be performed such that the number of magazine slots occupied by tools other than the tools before the optimization is as low as possible.

One development of embodiments of the invention provides for a set of magazine slots that are each permanently occupied by a tool to be detected that cannot be occupied by other tools as a result of the optimization.

One development of embodiments of the invention provides for the optimization of the occupancy of the magazine slots by tools to be performed such that the tools for which the waiting period assumes the value zero are placed in magazine slots close to the supply point.

The embodiments entails the following advantages:

The optimization entails shorter paths of movement of the magazine device of a shelf-type magazine, which ultimately also results in energy savings and longer durability. This is also accompanied by shorter production times for the machine tools.

A further aspect of embodiments of the invention provides for a control facility that is in particular designed to perform the method of the aforementioned type and the embodiments thereof. The control facility (not shown in FIG. 1) can be a computer associated with the machine tool, and possibly arranged remotely, or a control module integrated in the machine tool.

The control facility for computer-aided optimization of an occupancy of magazine slots by tools within at least one tool magazine for a machine tool, wherein one or more workpieces of a workpiece type are manufactured using the tools provided by a magazine device at a supply point, has:
a) means for detecting or a detector a set of magazine slots in at least one tool magazine,
b) means for detecting or a detector for a set of tools,
c) means for detecting or a detector for permissible tools per magazine slot,
d) means for detecting or detector for a sequence of work steps to be performed by the machine tool on a workpiece, wherein a tool envisaged for a work step of the sequence can be used to manufacture the workpiece,
e) means for detecting or a detector for work step times that are each needed to perform an individual work step on the workpiece,
f) means for detecting or a detector for one or more supply times, on the basis of the sequence of work steps to be performed and the occupancy of the magazine slots, that are each needed by the magazine device at the supply point to provide a tool for the next work step, and
g) means for optimizing or an optimizer for the occupancy of the magazine slots by tools, so that the result of the optimization is that the overall waiting period is minimized, wherein the overall waiting period is made up of individual waiting periods that each result from the difference between the detected supply time and the detected work step time if the value of the difference is positive, otherwise the individual waiting period assumes the value zero.

A further aspect of embodiments of the invention is a computer program (product) having program code means for performing the method as claimed in one of the preceding method claims when the computer program (product) runs on a control facility of the aforementioned type or is stored on a computer-readable medium.

The computer program or a computer program product (non-transitory computer readable storage medium having instructions, which when executed by a processor, perform actions)can be stored on a computer-readable medium. The computer program or computer program product can be created in a standard programming language (e.g. C++, Java). The processing facility can comprise a standard computer or server on the market having appropriate input, output and storage means. This processing facility can be integrated in the control facility or in the means thereof.

The control facility and the computer program (product) can be developed or designed analogously to the aforementioned method.

### BRIEF DESCRIPTION

Some of the embodiments will be described in detail, with reference to the following figures, wherein like designations denote like members, wherein:

FIG. 1 shows the slots in a shelf-type magazine that were mentioned at the outset, wherein the main side is arranged to the right and the opposite side is arranged to the left;

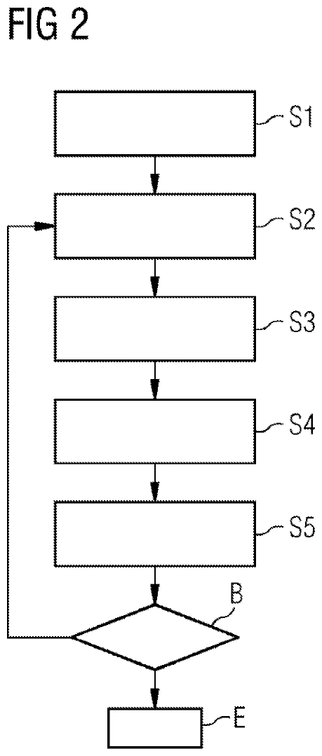

FIG. 2 schematically shows a flowchart for the iterative method with a starting configuration, the iterative method involving the use of the heuristic integer linear optimization method;

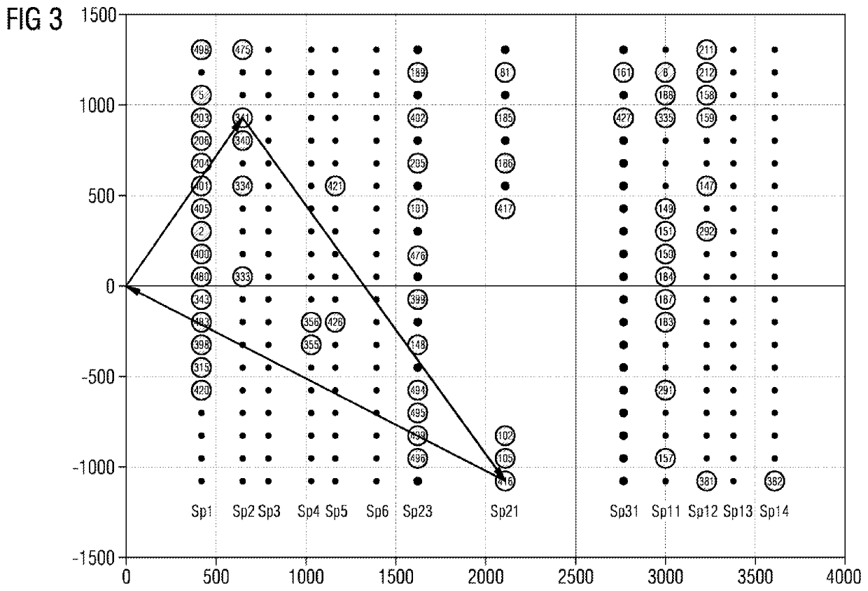

FIG. 3 shows an initial occupancy and an optimized occupancy using the mixed integer linear optimization method;

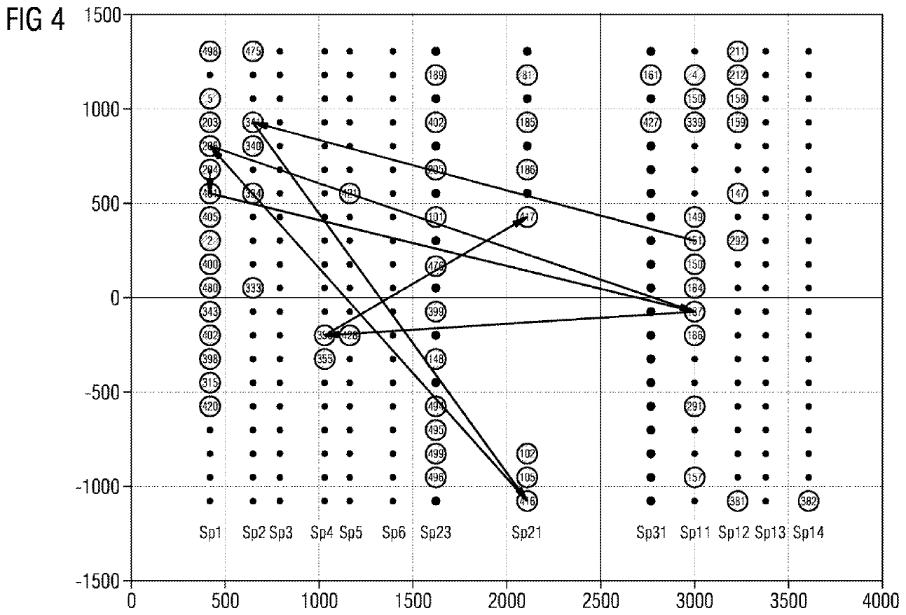

FIG. 4 depicts an initial occupancy of the magazine slots by tools;

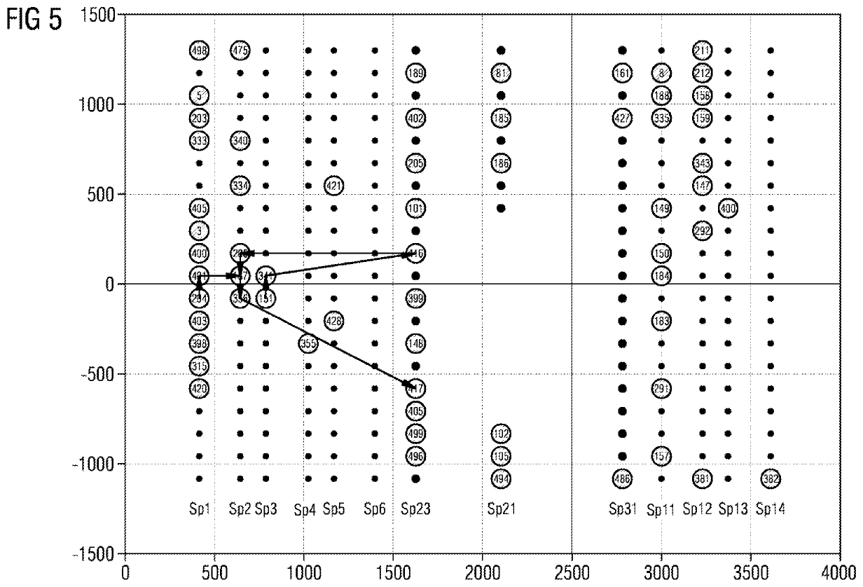

FIG. 5 depicts an initial optimized occupancy of the magazine slots by tools.

### DETAILED DESCRIPTION

A special case of optimization methods is linear optimization. It is concerned with the optimization of linear target functions over a set that is limited by linear equations and inequations. It is the basis of the solution processes of (mixed) integer linear optimization. What is known as a solver is a collective name for specific mathematical computer programs that can solve mathematical problems numerically. In association with MILP (mixed integer linear programming), standard solvers such as e.g. CPLEX, Scip, Gurobi, Xpress can be used for IP programs (integer optimization models).

The text below describes an example in which an MILP (mixed integer linear programming) model is used to perform a computer-aided optimization of an occupancy of magazine slots by tools within at least one tool magazine for a machine tool, wherein one or more workpieces of a workpiece type can be manufactured by means of an occupancy of the magazine slots by tools.

The following designations apply in the MILP formulation:

Indexes:
L Set of all magazine slots
T Set of the tools
HP Set of all half-slots
HP_{l,t} Set of the half-slots covered when tool t is in magazine slot l
W Set of the workpiece types
Op_{w} Sequence of work steps (or operations) to be performed by the machine tool for workpiece type w
OP_{w}=(OP_{w}¹, . . . , OP_{w}ⁿ^{_{w}})
Tₗ Set of the tools permissible for magazine slot l

Parameters:
quantity_{w} Quantity to be manufactured of workpiece type w
tⁱ_{w} Tool in Opⁱ_{w}
prodTimeⁱ_{w} Time of Opⁱ_{w}
putTime_{t,l} Time for returning or replacing tool t from the supply point to the magazine slot l
getTime_{t,l} Time for fetching tool t from the magazine slot l to the supply point
moveTime_{l,l′} Time for the empty run from the magazine slot l to the magazine slot l′
moveTimeₗ Time for the empty run from the supply point to the magazine slot l

Variables:
setup_{t,l} Allocation or assignment of tool t to magazine slot l
(In this case, it assumes the value 1, otherwise the value 0)
covers_{t,h} Tool t covers the half-slot h
(In this case, it assumes the value 1, otherwise the value 0)
waitingTimeⁱ_{w} (Individual) waiting period arising in the manufacture of a workpiece of workpiece type w after operation i

QIP Formulation (Quadratic IP Formulation):

Minimization Target Function:

$${\sum }_{w ∈ W} {\sum }_{i = 1}^{{n}_{w}} {quantity}_{w} {waitingTime}_{w}^{i}$$

Constraints:
(1) Every tool must be in a magazine slot.

$${\sum }_{l ∈ L} {setup}_{t , l} = 1 t ∈ T$$

(2) There must no more than one tool in a magazine slot.

$${\sum }_{t ∈ T} {setup}_{t , l} \leq 1 l ∈ L$$

(3) There must not be a tool that is prohibited for a magazine slot in this magazine slot.

$${\sum }_{t ∈ T \backslash {T}^{l}} {setup}_{t , l} = 0 l ∈ L$$

(4) A half-slot must be covered by no more than one tool.

$${\sum }_{t ∈ T} {covers}_{t , h} \leq 1 h ∈ H$$

(5) If a tool is in a slot, it covers the corresponding half-slots

$${\sum }_{h ∈ {HP}_{l , t}} {covers}_{t , h} \geq {setup}_{t , l} \vert {HP}_{l , t} \vert h ∈ H$$

(6) A waiting period arises if the operation Opⁱ_{w} is shorter than the time that the magazine needs for replacing the previous tool used for the preceding operation, the intermediate or empty run to the next tool and fetching the next tool used for the subsequent operation.

For all l ∈ L, l′ ∈ L, w ∈ W, i=2, . . . , n−1, it holds that:

$${waitingTime}_{w}^{i} \geq {\sum }_{l ∈ L} {putTime}_{t , l} {setup}_{{t}_{w}^{i - 1} , l} + {\sum }_{{l}^{′} ∈ L} {getTime}_{t , {l}^{′}} {setup}_{{t}_{w}^{i + 1} , {l}^{′}} + {\sum }_{l ∈ L} {\sum }_{{l}^{′} ∈ L} {moveTime}_{l , {l}^{′}} {setup}_{{t}_{w}^{i} , l} {setup}_{{t}_{w}^{i} , {l}^{′}} - {prodTime}_{w}^{i}$$

A waiting period arises after the first operation if the empty run from the supply point to the magazine slot of the tool for the next second operation takes longer than the first operation.

For i=1, it holds for all l ∈ L, w ∈ W that:

$${waitingTime}_{w}^{1} \geq {\sum }_{l ∈ L} {getTime}_{t , l} {setup}_{{t}_{w}^{2} , l} + {\sum }_{l ∈ L} {moveTime}_{l} {setup}_{{t}_{w}^{2} , l} - {prodTime}_{w}^{1}$$

(7) Variable restrictions,
setup_{t,l} ∈ {0,1} t ∈ T, l ∈ L
covers_{t,h} ∈ {0,1} t ∈ T, h ∈ HP
   waitingTime_{w}ⁱ≥0 w ∈ W, i=1, . . . , n_{w}

MILP Reformulation:

The test problem with 250 slots, 60 tools and 20 operations is not solvable using the QIP formulation. The QIP is therefore formulated as MILP:

Additional Variables:
H_{w,i,l,l′} Auxiliary variable that assumes the value 1 if tⁱ⁻¹_{w} is in slot l and tⁱ⁺¹_{w} is in magazine slot l′ and hence an empty intermediate run from l to l′ is required.

Modified Restrictions:

The restrictions (6) are replaced by the restrictions (9).
(8) If the tools tⁱ⁻¹_{w} and tⁱ⁺¹_{w} are in magazine slot l and magazine slot l′, respectively, then h_{w,i,l,l′}=1
setupₜ_{_{w}}_{^{i−1}}_{,l}+setupₜ_{_{w}}_{ⁱ⁺¹}_{,l′}≤h_{w,i,l,l′}+1 w ∈ W, l ∈ L, l′ ∈ L, i=1, . . . , n_{w}
(9) If h_{w,l,l′}=1, an empty intermediate run is made from l to l′.

For all l ∈ L, l′ ∈ L, w ∈ W, i=2, . . . , n_{w}−1, it holds that:

$${waitingTime}_{w}^{i} \geq {\sum }_{l ∈ L} {putTime}_{t , l} {setup}_{{t}_{w}^{i - 1} , l} + {\sum }_{{l}^{′} ∈ L} {getTime}_{t , {l}^{′}} {setup}_{{t}_{w}^{i + 1} , {l}^{′}} + {\sum }_{l ∈ L} {\sum }_{{l}^{′} ∈ L} {moveTime}_{l , {l}^{′}} {h}_{w , i , l , {l}^{′}} - {prodTime}_{w}^{i}$$

For i=1, it furthermore holds for all l ∈ L, w ∈ W that:

$${waitingTime}_{w}^{1} \geq {\sum }_{l ∈ L} {getTime}_{t , l} {setup}_{{t}_{w}^{2} , l} + {\sum }_{l ∈ L} {moveTime}_{l} {setup}_{{t}_{w}^{2} , l} - {prodTime}_{w}^{1}$$

If the tools tⁱ⁻¹_{w} and tⁱ⁺¹_{w} are not in magazine slot l and magazine slot l′, respectively, then the minimization target function ensures that it holds that h_{w,i,l,l′}=0.

Performance Measures:

In order to decrease the operating time, also called performance, the following further performance measures are useful.

Consideration of Exclusively Critical Operations:

The maximum time for a cycle (returning or replacing, intermediate run and fetching (collecting)) can be calculated. In (9), it is therefore possible to provide a restriction only to the operations have that a shorter production time than the maximum cycle time. These operations are referred to as critical. Critical tools refer to those tools that need to be returned to or fetched from the shelf-type magazine during critical operations.

Limitation of the Solution Space:

Depending on the number of critical tools, the solution space for the possible magazine slots of the critical tools can be limited, since the time for returning and fetching the tools increases as the distance from the supply point becomes greater.

Journey times to the opposite side of the shelf-type magazine are extremely long. If only a few tools are critical, it is possible e.g. to dispense with the complete opposite side as potential magazine slots for the critical tools.

Additional Restrictions (Cuts):

$${setup}_{{t}_{w}^{i - 1} , l} \geq {\sum }_{{l}^{′} ∈ L} {h}_{w , i , l , {l}^{′}} w ∈ W , l ∈ L , i = 2 , … , {n}_{w} - 2$$

$${setup}_{{t}_{w}^{i + 1} , {l}^{′}} \geq {\sum }_{l ∈ L} {h}_{w , i , l , {l}^{′}} w ∈ W , {l}^{′} ∈ L , i = 2 , … , {n}_{w} - 2$$

Lower Bounds:

It is possible to ascertain minimum cycle times, which, minus the production time, provide a lower bound for the waiting period.
waitingTime_{w}ⁱ≥lb_{w}ⁱ w ∈ W, i=1, . . . , n_{w}−2

Extensions:

A target function made up of multiple waited components allows further target criteria to be optimized as well. Accordingly, a starting tool magazine slot occupancy is detected and the maximization of the number of concordant occupancies between the starting occupancy and the optimized occupancy is deemed a second, less highly weighted target criterion. The main criterion remains the minimization of the waiting period.

Preference for Old Magazine Slots:

The new occupancy of the magazine slots by tools that is calculated by the optimization needs to be produced physically in the machine tool by means of conversions. During this period, the machine tool is probably at a standstill. It is therefore advantageous if the optimization results in a tool t landing up in the old magazine slot l^{old}ₜ where possible and therefore the number of such tools is maximized:

$${\sum }_{t ∈ T} {setup}_{t , {l}_{t}^{old}}$$

Storing Relocated Tools Close to the Supply Point:

Additionally, it can make sense for visual reasons and also for performance reasons if, by means of a very low weighting, the relocated, noncritical, tools land up close to the supply point and therefore the sum of the intervals of time between the tools and the supply point is minimized.

$${\sum }_{l ∈ L} {\sum }_{t ∈ T} {getTime}_{t , l} {setup}_{t , l}$$

Fixed-Setup Tools:

For a set of FixedSetups of pairs (t,lₜ) with t ε T and lₜ ε L, the following is specified:
setup_{t,l}_{ₜ}=1

MILP Heuristics:

For large problem instances, the performance is not adequate and the following MILP-based heuristics are proposed therefore to minimize the waiting periods for a workpiece type:

For a FixedSetup set of tool/magazine-slot pairs and an OpSubset set of operations (w,i), MILP(FixedSetup, OpSubset) will be the MILP (see above) with additionally fixed-setup tools according to the FixedSetup set and a limitation of the restriction (9) to the operations of the OpSubset set, i.e. only the waiting periods of the operations from OpSubset are minimized.

According to FIG. 2, the iterative procedure is as follows: After step S1 (Start), the assumption is a sequence or list (Set) of operations or work steps (ListOp) sorted in ascending order according to the production time, wherein ListOp comprises all work steps needed for producing the workpiece type, apart from the first and last work steps (the order of the work steps on this sorted list usually no longer corresponds to the order of the work steps within the sequence, in the way in which they are processed using the machine tool). A set containing fixed-setup tools and respective associated magazine slots (FixedSetup) begins with an empty set. In step S2, the first operation op1 or work step to be performed is selected from the list ListOp (operation with shortest machining time). For the first operation op1, there is a predecessor and a successor tool pair (tp, ts), tp being used in the preceding work step and ts being used in the subsequent work step.

According to step S3, the OpSubset set comprises all operations whose predecessor and successor tools are already in a fixed setup or are the same as the aforementioned tp and ts. In step S4, an optimization is performed using a MILP formulation MILP(FixedSetup, OpSubset). In step S5, operation op1 is removed from the list ListOp. The tools tp, ts are included in the FixedSetup set with the magazine slots that result from the optimization and that are assigned and also permissible, FixedSetup comprising respective pairs of a tool and the associated magazine slot. FixedSetup therefore expresses the occupancy of the magazine slots by tools. After condition B is satisfied, the method is finished, this being denoted by E. The tool/magazine-slot association of the MILP solution in this iteration is then the solution of the heuristic. Otherwise, the method is continued or repeated with step 2. The condition is satisfied if ListOp is empty. Ultimately, an optimized occupancy is supposed to result from this MILP heuristic, which ultimately leads to a minimization of the overall waiting period described at the outset. An individual waiting period a work step is obtained from the positive value of the difference between the replace time for replacing the tool tp envisaged for the preceding work step, the empty-run time of the empty run by the magazine device from the magazine slot of the tool ts envisaged for the preceding work step to the magazine slot of the tool tp envisaged for the subsequent work step, and also the fetch time for fetching the tool ts envisaged for the subsequent work step and the detected time of the work step that is currently to be performed.

The heuristic can also be extended to multiple workpiece types having identical or different amounts of workpieces to be manufactured per type by means of appropriate prioritization/reordering of ListOp.

In FIGS. 3 to 5 that follow, a shelf-type magazine is depicted with initial occupancy and optimized occupancy. The left-hand part of the graphic shows the main side of the shelf-type magazine R to scale. The opposite side is depicted on the right-hand part of the graphic, likewise to scale. This type of two-dimensional depiction has been chosen because the times for moving from a supply point at the point (0,0) in the depicted coordinate system to the opposite side are much longer than to the main side.

In the columns 23, 21 and 31 shown therein, there are the magazine slots for the larger tools. The tools are provided with numbers.

The dots represent the magazine slots, the small dots being the magazine slots in which there are only smaller tools and the large dots being those magazine slots in which there can be either smaller or larger tools. The shaded circular disks represent the primed tools. The light-colored circular disks represent the tools of the operations.

In the cycle depicted in FIG. 3, the tool 341 is first put back or returned, an empty run is then made to the magazine slot of the tool 416 and the tool 416 is taken to the supply point.

Normally, it holds that: the closer the light-colored circular disks are to the supply point and the shorter the distances of the intermediate runs, the shorter are the waiting periods.

FIGS. 4 and 5 that follow depict an initial occupancy of the magazine slots by tools (FIG. 4) and the optimized occupancy (FIG. 5) and also the empty runs, which are denoted by lines. The line from 151 to 341 means e.g. that in one cycle, the tool 151 needs to be put back, an empty run is made from the magazine slot of the tool 151 to the magazine slot of the tool 341, and the tool 341 subsequently needs to be taken to the supply point. It can be seen that, in FIG. 5, the relocation of the tools, i.e. new occupancy of the magazine slots by tools, means that shorter paths are needed for the empty runs and the paths for collecting and putting back the tools are likewise shorter than in FIG. 4.

The implementation of the processes or method sequences described above can be provided on the basis of instructions that are available on computer-readable storage media or in volatile computer memories (referred to collectively below as computer-readable memories). Computer-readable memories are for example volatile memories such as caches, buffers or RAM and also nonvolatile memories such as removable data carriers, hard disks, etc.

The functions or steps described above can be present here in the form of at least one instruction set in/on a computer-readable memory. In this case, the functions or steps are not tied to a specific instruction set or to a specific form of instruction sets or to a specific storage medium or to a specific processor or to specific execution schemes and can be implemented by software, firmware, microcode, hardware, processors, integrated circuits, etc., in standalone operation or in arbitrary combination. In this case, a wide variety of processing strategies can be employed, for example serial processing by a single processor or multiprocessing or multitasking or parallel processing, etc.

The instructions can be stored in local memories, but it is also possible to store the instructions on a remote system and to access them via a network.

“Computer-aided” can be understood within the context of embodiments of the invention to mean for example an implementation of the method in which in particular a processor carries out at least one method step of the method.

The term “processor”, “central signal processing”, “control unit” or “data evaluation means or evaluator”, as used here, encompasses processing means or processor in the broadest sense, that is to say for example servers, general purpose processors, graphics processors, digital signal processors, application-specific integrated circuits (ASICs), programmable logic circuits such as FPGAs, discrete analog or digital circuits and arbitrary combinations thereof, including all other processing means or processor that are known to a person skilled in the art or will be developed in the future. In this case, processors can consist of one or more apparatuses or facilities or units. If a processor consists of multiple apparatuses, the latter can be designed or configured for the parallel or sequential processing or execution of instructions. A “memory unit” can be understood within the context of embodiments of the invention to mean for example a memory in the form of random-access memory (RAM) or a hard disk.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method for computer-aided optimization of an occupancy of magazine slots by tools within at least one tool magazine for a machine tool, wherein one or more workpieces of a workpiece type are manufactured by using the tools provided by a magazine device at a supply point, comprising the following steps:
a) detecting a set of magazine slots in at least one tool magazine,
b) detecting a set of tools,
c) detecting permissible tools per magazine slot,
d) detecting a sequence of work steps to be performed by the machine tool on a workpiece, wherein a tool envisaged for a work step of the sequence is used to manufacture the workpiece,
e) detecting work step times that are each needed to perform an individual work step on the workpiece,
f) detecting one or more supply times, on the basis of the sequence of work steps to be performed and the occupancy of the magazine slots, that are each needed by the magazine device at the supply point to provide a tool for the next work step, and
g) optimizing the occupancy of the magazine slots by tools, so that the overall waiting period is minimized, wherein the overall waiting period is made up of individual waiting periods that each result from the difference between the detected supply time and the detected work step time if the value of the difference is positive, otherwise the individual waiting period assumes the value zero.

2. The method as claimed in claim 1, wherein the supply time is made up of a fetch time, which comprises the time for the magazine device to fetch a tool to the supply point from one magazine slot permissible for the tool, and of a replace time, which comprises the time for the magazine device to replace a tool from the supply point to one magazine slot permissible for the tool, and of an empty-run time for an empty run by the magazine device from a first magazine slot to another, second magazine slot.

3. The method as claimed in claim 1, wherein a set of workpiece types and quantities of the workpieces to be manufactured of each workpiece type of the set is detected and allowance is made for these when optimizing the occupancy of the magazine slots by tools.

4. The method as claimed in claim 1, wherein the optimization is performed by mixed integer linear optimization.

5. The method as claimed in claim 1, characterized by further steps of:
detecting a set of all half-slots,
detecting a subset of half-slots covered whenever there is a tool in one magazine slot,
wherein allowance is made for these sets when optimizing the occupancy, with the aim of no half-slot being covered by multiple tools.

6. The method as claimed in claim 1, wherein the optimization of the occupancy of the magazine slots by tools is performed such that the number of magazine slots occupied by tools other than the tools before the optimization is as low as possible.

7. The method as claimed in claim 1, wherein a set of magazine slots that are each permanently occupied by a tool is detected that cannot be occupied by other tools as a result of the optimization.

8. The method as claimed in claim 1, wherein the optimization of the occupancy of the magazine slots by tools is performed such that the tools for which the waiting period assumes the value zero are placed in magazine slots close to the supply point.

9. The method as claimed in claim 1, wherein the optimization is performed by a heuristic mixed integer linear optimization.

10. A control facility for computer-aided optimization of an occupancy of magazine slots by tools within at least one tool magazine for a magazine tool, wherein one or more workpieces of a workpiece type are manufactured using the tools provided by a magazine device at a supply point, comprising:
a) a detector for a set of magazine slots in at least one tool magazine,
b) a detector for a set of tools,
c) a detector for permissible tools per magazine slot,
d) a detector for a sequence of work steps to be performed by the machine tool on a workpiece, wherein a tool envisaged for a work step of the sequence can be used to manufacture the workpiece,
e) a detector for work step times that are each needed to perform an individual work step on the workpiece,
f) a detector for one or more supply times, on the basis of the sequence of work steps to be performed and the occupancy of the magazine slots, that are each needed by the magazine device at the supply point to provide a tool for the next work step, and
g) an optimizer for the occupancy of the magazine slots by tools, so that the result of the optimization is that the overall waiting period is minimized, wherein the overall waiting period is made up of individual waiting periods that each result from the difference between the detected supply time and the detected work step time if the value of the difference is positive, otherwise the individual waiting period assumes the value zero.

11. The control facility as claimed in claim 10, wherein the supply time is made up of a fetch time, which comprises the time for the magazine device to fetch a tool to the supply point from one magazine slot permissible for the tool, and of a replace time, which comprises the time for the magazine device to replace a tool from the supply point to one magazine slot permissible for the tool, and of an empty-run time for an empty run by the magazine device from a first magazine slot to another, second magazine slot.

12. The control facility as claimed in claim 10, wherein the control facility additionally has detector for a set of workpiece types and quantities of the workpieces to be manufactured of each workpiece type of the set, allowance being able to be made for these when optimizing the occupancy of the magazine slots by tools.

13. The control facility as claimed in claim 10, characterized by:
detector for a set of all half-slots,
detector for a subset of half-slots covered whenever a tool is in one magazine slot, and
wherein allowance can be made for these sets when optimizing the occupancy, with the aim of no half-slot being able to be covered by multiple tools.

14. A computer program product, comprising a computer readable hardware storage device having computer readable program code stored therein, said program code executable by a processor of a computer system to implement a method having program code for performing the method as claimed in claim 1 when the computer program product runs on a control facility or is stored on a computer-readable medium.

15. A control facility for computer-aided optimization of an occupancy of magazine slots by tools within at least one tool magazine for a magazine tool, wherein one or more workpieces of a workpiece type are manufactured using the tools provided by a magazine device at a supply point, comprising:
a) means for detecting a set of magazine slots in at least one tool magazine,
b) means for detecting a set of tools,
c) means for detecting permissible tools per magazine slot,
d) means for detecting a sequence of work steps to be performed by the machine tool on a workpiece, wherein a tool envisaged for a work step of the sequence can be used to manufacture the workpiece,
e) means for detecting work step times that are each needed to perform an individual work step on the workpiece,
f) means for detecting one or more supply times, on the basis of the sequence of work steps to be performed and the occupancy of the magazine slots, that are each needed by the magazine device at the supply point to provide a tool for the next work step, and
g) means for optimizing the occupancy of the magazine slots by tools, so that the result of the optimization is that the overall waiting period is minimized, wherein the overall waiting period is made up of individual waiting periods that each result from the difference between the detected supply time and the detected work step time if the value of the difference is positive, otherwise the individual waiting period assumes the value zero.
